(19) United States
(12) Patent Application Publication
(10) Pub. No.: US 2016/0104890 A1
(43) Pub. Date: Apr. 14, 2016

(54) ELECTRODE COMPOSITIONS AND RELATED ENERGY STORAGE DEVICES

(71) Applicant: General Electric Company, Schenectady, NY (US)

(72) Inventors: Richard Louis Hart, Broadalbin, NY (US); Michael Alan Vallance, Albany, NY (US); Brandon Alan Bartling, Bethlehem, NY (US); Ayesha Maria Gonsalves, Schenectady, NY (US)

(21) Appl. No.: 14/513,294

(22) Filed: Oct. 14, 2014

(51) Int. Cl. H01M 4/58; H01M 10/39; H01M 4/583

(52) U.S. Cl. CPC H01M 4/5815; H01M 4/583; H01M 10/399; H01M 2300/0057; H01M 2220/20

(57) ABSTRACT

A positive electrode composition is presented. The composition includes granules that comprise an electroactive metal, an alkali metal halide, sulfur and carbon. A molar ratio of the electroactive metal to an amount of sulfur in the composition is between about 1.5:1 and about 10:1. Carbon is present in an amount greater than about 0.1 and less than about 5 weight percent, based on a total weight of the granules. An energy storage device and a related energy storage system are also described.

### BACKGROUND

The present disclosure generally relates to electrode compositions. More specifically, the present disclosure relates to compositions for use as positive electrode materials in energy storage devices. The disclosure also includes energy storage devices that utilize such electrode compositions.

Metal halide batteries are widely employed for energy storage applications. In particular, metal chloride batteries including a molten sodium negative electrode (anode) and a beta-alumina solid electrolyte, are of considerable interest for use in industrial vehicles, telecommunication, utility applications, and uninterruptible power supply (UPS) devices. In addition to the anode, the batteries include a positive electrode (cathode) that supplies/receives electrons during the charge/discharge of the battery. The positive electrode of such batteries is usually built from nickel metal, sodium chloride (NaCl) and a molten electrolyte such as sodium tetrachloroaluminate NaAlCl₄.

Current development of the sodium-metal chloride batteries is focused on the improvement of the performance and the cycle life. When these metal halide batteries are employed in mobile and utility applications, such as hybrid locomotives or plug-in electric vehicles (PHEV), the battery should tolerate power surges (high currents) during both charging and discharging, without a loss in the capacity and the cycle life. Generally, when these batteries are discharging using high discharge current rates (e.g., at 110 W/cell for a 110 W-h cell), multiple discharge cycles may be conducted with no significant increase in the resistance, increase in the charging time, or loss of the capacity. However, when discharging at low discharge currents, the sodium metal halide batteries may degrade very rapidly, and the charging rate is low (i.e. the charging time may increase).

A common way to improve the performance of these batteries is an addition of a small amount of various additives to the positive electrode composition. The use of sodium salts of other halogens (NaF, NaBr and NaI), and/or elemental sulfur as additives has been tried. Addition of iron monosulfide (FeS) instead of elemental sulfur allowed for better sulfur distribution in the electrode material and less variability. High amounts of sulfur in the positive electrode (U.S. Pub. No. 20140178791A1) have shown an improvement in the charging rate and a reduction in the degradation rate, and thereby improvements in the performance of a battery as compared to a battery having a small or negligible amount of sulfur in the positive electrode. However, a battery that includes high sulfur in the positive electrode (high-sulfur containing battery/cell), exhibits reduced performance (e.g., capacity loss, slow charging) under some circumstances, for example when cycled over its entire capacity range, which may be required in certain applications.

There continues to be a growing need in the art for an improved solution to the long-standing problem of the performance and the cycle life of the batteries. It may be desirable to have an electrode material that further improves the performance of a sodium-metal chloride battery.

### BRIEF DESCRIPTION

One embodiment of the invention is directed to a positive electrode composition. The composition includes granules that comprise an electroactive metal, an alkali metal halide, sulfur and carbon. A molar ratio of the electroactive metal to the amount of sulfur in the composition is between about 1.5:1 and about 10:1. Carbon is present in an amount greater than about 0.1 weight percent and less than about 5 weight percent, based on a total weight of the granules.

Another embodiment is directed to an energy storage device. The device includes a first compartment comprising an alkali metal, a second compartment comprising a positive electrode composition, and a solid separator capable of transporting alkali metal ions between the first compartment and the second compartment. The positive electrode composition includes:

(a) an electrolyte comprising a complex metal halide; and
(b) granules that themselves comprise:
(i) an electroactive metal,
(ii) an alkali metal halide,
(iii) an amount of sulfur, wherein a molar ratio of the electroactive element to the amount of sulfur in the granules is between about 1.5:1 and about 10:1; and
(iv) an amount of carbon greater than about 0.1 weight percent and less than about 5 weight percent based on the total weight of the granules.
   An energy storage system including a plurality of the energy storage devices is also provided in one embodiment.

### BRIEF DESCRIPTION OF THE DRAWINGS

FIG. 1 is a schematic, cross-sectional view of a portion of an energy storage device, in accordance with some embodiments of the invention.

FIG. 2 is a schematic, cross-sectional view of a portion of an energy storage device, in accordance with some embodiments of the invention.

FIG. 3 shows a graph comparing charge times of a comparative energy storage device and experimental energy storage devices, in accordance with some embodiments of the invention.

FIG. 4 shows a graph comparing discharge capacities of a comparative energy storage device and experimental energy storage devices, in accordance with some embodiments of the invention.

FIG. 5 shows another graph comparing discharge capacities of a comparative energy storage device and experimental energy storage devices, in accordance with some embodiments of the invention.

FIG. 6 shows a graph depicting voltage response of an experimental energy storage device and a comparative energy storage device for 40th, 59th and 80th discharge cycles.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value.

In the following specification and claims, the singular forms “a”, “an” and “the” include plural referents unless the context clearly dictates otherwise. As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

As used herein, “positive electrode composition” (or “cathode material”, “cathode composition”, “positive electrode material” or “cathodic material), which may all be used interchangeably) is the material that supplies electrons during charge and is present as part of a redox reaction. “Negative electrode composition” (or “anode material”, “anodic material” or “negative electrode material”) accepts electrons during charge and is present as part of the redox reaction.

An electrolyte is a medium that provides the ion transport mechanism between the positive and the negative electrodes of a device/cell, and may act as a solvent for the oxidized form of the positive electrode material. Additives that facilitate the primary redox process, but do not themselves provide the primary redox process, are distinguished from the electrolyte itself.

As discussed in detail below, some embodiments of the invention provide a positive electrode composition including granules that are comprised of an electroactive metal, an alkali metal halide, sulfur and carbon. A molar ratio of the electroactive metal to an amount of sulfur in the composition is between about 1.5:1 and about 10:1. Carbon is present in a small amount, greater than about 0.1 weight percent and less than about 5 weight percent, based on a total weight of the granules.

“Granules”, as used herein, refers to particles of a variety of shapes, sizes and geometries. Granules may be in the state of coarse particles or a powder. In one embodiment, the particle may have a shape that is a sphere, a cube, a plate, a flake or a whisker. In some embodiments, a cross sectional geometry of the particles in the granules may be one or more of circular, ellipsoidal, triangular, rectangular, or polygonal. In some embodiments, the particles may be irregular in shape. The granules may include particles having one or more of the aforementioned shapes and/or geometries.

The electroactive metal, as used herein, is a metal that oxidizes in molten sodium tetrachloroaluminate, resulting in a metal halide salt above the oxidation potential of aluminum (about 1.58 V vs. Na/Na ion), and below the oxidation potential of chloride (about 4.15 V vs. Na/Na ion). In some embodiments, the granules of the positive electrode composition (or the positive electrode granules) include an electroactive metal selected from the group consisting of nickel, iron and cobalt. Additional suitable examples of the electroactive metals may include titanium, vanadium, niobium, molybdenum, chromium, manganese, silver, antimony, cadmium, tin, lead, copper and zinc. Combinations of any of these metals are also possible. Usually, the metals are obtained as powders from various commercial sources.

In some specific embodiments, the positive electrode granules include nickel. Very often, nickel is the most preferred electroactive metal, in view of various attributes, including cost, availability, the high reduction potential (“redox potential”) of nickel relative to sodium/sodium ion (Na/Na ion); and the low solubility of the nickel cations in the positive electrode composition. Nickel usually serves as the electronic conduction grid (i.e., a conductive structure or network) in the electrode. In some embodiments, the positive electrode granules include at least two electroactive metals. For example, the granules may include nickel and iron.

Generally, the electroactive metal is present in an elemental form during the preparation of the granules or the construction of a positive electrode. In some embodiments, the electroactive metal may optionally include a salt form of the electroactive metal. In one embodiment, the electroactive metal salt may be in the form of a nitrate, sulfide, or halide of the electroactive metal. The halide salts are preferred in some instances.

The alkali metal halide is typically present in the positive electrode composition to promote the desired electrochemical reaction for an electrochemical cell or an energy storage device of interest. The alkali metal halide may include a halide selected from chloride, bromide, fluoride and iodide. In some embodiments, the halides of sodium, potassium, or lithium are used. In some embodiments, the positive electrode composition includes at least one halide selected from sodium chloride, sodium iodide, sodium bromide, sodium fluoride, potassium chloride, potassium iodide, potassium bromide, potassium fluoride, lithium chloride, lithium iodide, lithium bromide, lithium fluoride and cesium chloride. In some specific embodiments, the composition includes sodium chloride.

The positive electrode composition may further include some additives that beneficially affect the performance of the energy storage device/cell. Such performance additives may increase the ionic conductivity, increase or decrease the solubility of the charged cathode species, improve the wetting of the solid separator by the molten electrolyte; or prevent the ripening of the positive electrode material. In some embodiments, an additive may be present in an amount less than about 5 weight percent (e.g., with a minimum level of about 0.1 weight percent), based on a total weight of the alkali metal halide in the positive electrode composition. Examples of such additives include one or more additional metal halides, e.g., sodium iodide, sodium fluoride and sodium bromide. In some specific embodiments, sodium iodide, when present, is at a level of about 0.1 weight percent to about 0.9 weight percent, based on the total weight of the alkali metal halides present in the positive electrode composition. In some embodiments, sodium fluoride is present at a level of about 0.1 weight percent to about 3 weight percent, based on the total weight of the alkali metal halide present in the positive electrode composition. Some specific positive electrode compositions are described in copending application Ser. No. 13/034184 (D. Bogdan et al); filed on Feb. 24, 2011, and is incorporated herein by reference.

As noted, the granules of the positive electrode composition further include an amount of sulfur. Sulfur may be present in the form of molecular sulfur or a sulfur-containing compound, such as a metal sulfide. In some embodiments, an amount of sulfur is incorporated into the positive electrode composition during the step of the formation of the granules. Usually, sulfur is uniformly dispersed within the positive electrode composition.

In some specific embodiments, the sulfur-containing compound in the positive electrode composition may be a metal sulfide of formula MₓS_{y}, where M is selected from iron or cobalt; and a ratio of x to y is between about 0.5:1 and about 1.5:1. In some embodiments, M is iron. In other embodiments, M is cobalt. Non-limiting examples of the metal sulfides MₓS_{y} include FeS (troilite), FeS₂ (pyrite), pyrrhotite, CoS₂, Co₃S₄, and Co₉S₈. In certain embodiments, the metal sulfide is FeS. A skilled person will understand that x and y are not necessarily integers.

In these embodiments, cobalt is not meant to be utilized as both the electroactive metal and M. That is, if the electroactive metal includes cobalt, M is iron. If M is cobalt, the electroactive metal does not include a significant amount of cobalt (e.g., more than about 10 weight percent of the total electroactive metal). If the electroactive metal does not include cobalt, M may be selected from cobalt or iron. Similarly, if M is iron, the electroactive metal may include cobalt. In some embodiments in which the electroactive metal is nickel, there may be present more than one metal sulfide MₓS_{y} in the positive electrode composition; for example, the metal sulfide may include both FeS and CoS. Similarly, when M is iron, there may be present more than one electroactive metal, that is the granules may include both nickel and cobalt.

The sulfur (as discussed above) may be present in high amounts in the positive electrode composition. As described in U.S. Pub. No. 20140178791A1, the high amounts of the sulfur in the positive electrode attributes to the fast charging, and thus improves the charging performance of the cell/device. In some embodiments, a molar ratio of the electroactive metal to the sulfur (e.g., present in the metal-containing compound) in the positive electrode granules may range from about 1.5:1 to about 10:1. In some embodiments, the molar ratio of the electroactive metal to the sulfur is between about 2:1 and about 7:1. In some embodiments, the molar ratio of the electroactive metal to the sulfur is between about 2:1 and about 5:1. To be perfectly clear, when a range of the molar ratio, for example “between about 1.5:1 and about 10:1” is used, it is meant to include all values, including non-integer values, that fall between and including 1.5:1 and 10:1, for instance, 2.5:1, 4:1, 6.2:1, 7.5:1, 8.75:1, etc.

In some embodiments, a molar ratio of a total amount of an alkali metal in the alkali metal halide to the sulfur present in the electrode composition ranges from about 1.5:1 to about 50:1. In some embodiments, the molar ratio of the total amount of alkali metal in the alkali metal halide to the sulfur is between about 1.75:1 and about 10:1. In some embodiments, the molar ratio of the total amount of alkali metal in the alkali metal halide to the sulfur is between about 1.75:1 and about 5:1. In some embodiments, the molar ratio of the total amount of alkali metal in the alkali metal halide to the sulfur is between about 1.75:1 and about 3:1. In some embodiments, the molar ratio of the total amount of alkali metal in the alkali metal halide to the sulfur is between about 1.75:1 and about 2.5:1. As above, to be perfectly clear, when the term “between 1.75:1 and 10:1” is used, it is meant to include all values, including non-integer values, that fall between and including 1.75:1 and 10:1, for instance, 2:1, 2.1:1, 3.25:1, 7.5:1, 8.75:1, etc.

The positive electrode composition further includes an amount of carbon. In one embodiment, a volume of the electroactive metal is replaced by an equivalent volume of carbon. In most instances, a mass of carbon will not be the same as a mass of removed electroactive metal. As described in U.S. Publication 2013/0157140, the addition of a considerable amount of carbon in the positive electrode composition by replacing an amount of the electroactive metal may provide cost benefits, as well as improved performance of the cell/device. However, replacing a large portion of granules' electroactive metal with carbon may result in a lower capacity of the resulting cell/device. Thus, the amount of carbon must be optimized to balance the performance of the cell/device by the cost of the granules.

In some embodiments, carbon is present in an amount greater than about 0.1 weight percent and less than about 5 weight percent, based on a total weight of the granules. In some embodiments, the positive electrode granules include from about 0.5 weight percent to about 4 weight percent carbon, and in some specific embodiments, from about 1 weight percent to about 3 weight percent. In some embodiments, a molar ratio of carbon to the electroactive metal is between about 5:95 and about 25:75, inclusive. In some other embodiments, the molar ratio is between about 10:90 and about 20:80, inclusive. In still some other embodiments, the ratio is between about 10:90 and about 15:85, inclusive.

Furthermore, carbon may be present in form of carbon black or graphite. In some specific embodiments, carbon black is added to the granules to replace the electroactive metal. The carbon black used in these embodiments has certain beneficial characteristics. In some embodiments, the carbon black has a surface area in a range of about 50 m²/gram to about 1000 m²/gram. In some other embodiments, the carbon black has a surface area between about 50 m²/gram and about 600 m²/gram. Non-limiting commercial examples of carbon black may include Cabot XC72 and Cabot LBX101.

In some embodiments of the disclosure, it may be beneficial to treat the surface of the carbon black. Commercially available carbon black, for instance, often includes side groups such as oxygen complexes. The carbon black can be treated thermally to remove some of these side groups. For instance in one condition, the carbon black was heated in an inert atmosphere at about 550 degrees Celsius for an hour.

The carbon black may also be chemically treated to replace the protons of the side groups. This may be accomplished by making the carbon black acidic, and then neutralizing with a base. In one example, the carbon black was exposed to concentrated nitric acid at 60° C. for two hours. The solution was then exposed to aqueous 45% NaOH solution and heated at about 70 degrees Celsius for about six hours, then filtered and washed with deionized water repeatedly until the wash solution was neutral after filtering. Finally, the carbon black was dried in an oven at 250 degrees Celsius.

Often, the electroactive metal and the alkali metal halide may be present in the form of granules in the positive electrode composition. In some embodiments, an amount of sulfur and an amount of carbon (as discussed in the above embodiments) are incorporated into the positive electrode composition during the step of the formation of the granules. Usually, the amount of sulfur, the amount of carbon or both are uniformly dispersed within the positive electrode composition.

In some embodiments, the positive electrode composition further includes an electrolyte. In some embodiments, the positive electrode granules are infused with a molten electrolyte. In some embodiments, the molten electrolyte enables the transportation of the alkali ions from a solid separator (described later) to the positive electrode, and vice-versa. In one embodiment, the molten electrolyte includes a binary salt including an alkali metal halide and an aluminum halide. In a specific embodiment, the molten electrolyte is sodium tetrachloroaluminate (NaAlCl₄). In some embodiments, the molten electrolyte may include at least one additional metal halide, and forms a ternary or quaternary electrolyte.

In addition to the components discussed above, the positive electrode composition may include a number of other constituents, in some embodiments. As an example, aluminum may be included in the positive electrode composition in a form other than its form in the electrolyte salt, and other than as aluminum halide. In some embodiments, the aluminum may be added in the elemental form, e.g., aluminum metal flakes or particles. In some embodiments, the amount of elemental aluminum present in the positive electrode composition may be in a range from about 0.1 weight percent to about 1.5 weight percent, based on the total weight of the positive electrode granules.

In some embodiments, the electroactive metal includes nickel; the alkali metal halide includes at least one of sodium chloride, sodium fluoride, and sodium iodide; the metal sulfide includes iron sulfide; and carbon is present in the form of carbon black.

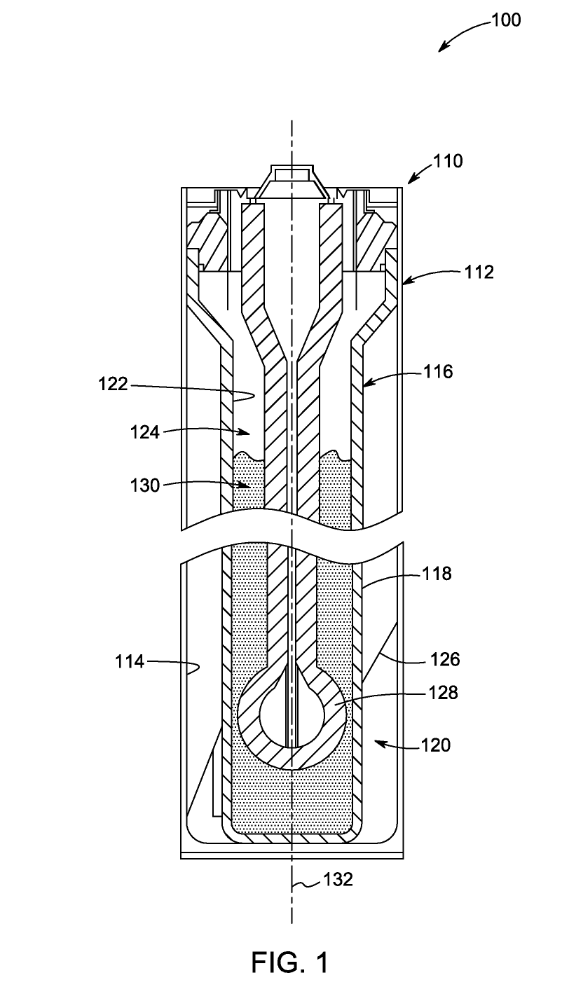

Another embodiment of the invention is directed to an energy storage device/electrochemical cell. Referring to FIG. 1, an energy storage device 100 is presented. More particularly, a cross-sectional view 110 of the device is depicted. The device 100 includes a housing 112. The housing 112 of the device or cell 100 may be sized and shaped to have a cross-sectional profile that is square, polygonal, or circular, for example. The housing may be formed from a material including a metal, ceramic, a composite; or combinations thereof. In some embodiments, a suitable metal may include nickel, iron, molybdenum, or an alloy thereof, e.g. steel.

The housing 112 usually has an interior surface 114, defining a volume. A separator 116 is disposed inside the housing 112. The separator 116 has a first surface 118 that defines a first compartment 120 (for example, an anode compartment); and a second surface 122 that defines a second compartment 124 (for example, a cathode compartment or a positive electrode compartment). The first compartment 120 is in ionic communication with the second compartment 124 through the separator 116. As used herein, the phrase “ionic communication” refers to the traversal of the ions between the first compartment 120 and the second compartment 124, through the separator 116. In some embodiments, the separator is capable of transporting alkali metal ions between the first and the second compartments. Suitable alkali metal ions may include one or more of sodium, lithium and potassium. In specific embodiments, the alkali metal ions include sodium.

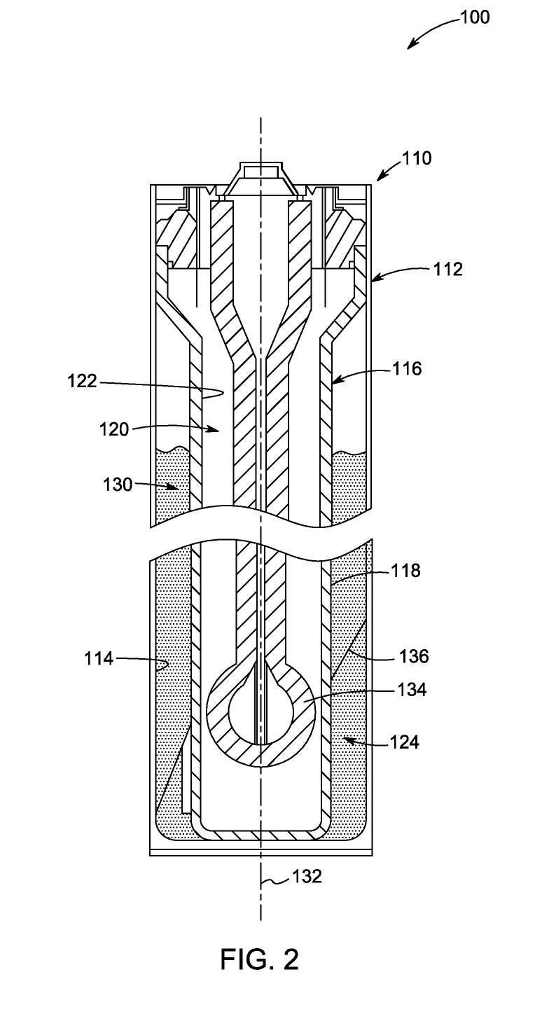

FIG. 1 depicts embodiments wherein the second compartment 124 is disposed within the first compartment 120. In such instances, the positive electrode compartment 124 is disposed within the anode compartment 120. In some other embodiments, the first compartment 120 may be disposed in the second compartment 124, as indicated in FIG. 2. In such instances, the anode compartment 120 is disposed within the positive electrode compartment 124.

In one embodiment, the first compartment or the anode compartment 120 contains an anodic material (not shown); and the second compartment or the positive electrode compartment 124 contains a positive electrode composition or a cathode material 130. Typically, the anode compartment 120 is empty in the ground state (uncharged state) of the cell 100. The anode compartment 120 is then filled with a metal from the reduced alkali metal ions that move from the positive electrode compartment 124 to the anode compartment 120 through the separator 116, during operation of the cell 100. The anode compartment 120 may receive and store a reservoir of the anodic material, in some embodiments. In one embodiment, the anodic material includes an alkali metal. Non-limiting examples of the anodic material may include lithium, sodium, or potassium. The anodic material is usually molten during use. In one embodiment, the anodic material is molten sodium metal.

In some embodiments, the anodic material may include one or more additives. Additives suitable for use in the anodic material may include a metallic oxygen scavenger. Suitable metal oxygen scavengers may include one or more of manganese, vanadium, zirconium, aluminum, or titanium. Other useful additives may include materials that increase wetting of the separator surface defining the anode compartment, by the molten anodic material. Additionally, some additives or coatings may enhance the contact or wetting between the separator and the current collector, to ensure substantially uniform current flow throughout the separator.

Further, as noted earlier, a positive electrode composition (or cathodic material) 130 is usually disposed inside the second compartment (positive electrode compartment) 124. In some embodiments, the positive electrode composition 130 includes granules comprising an electroactive metal, an alkali metal halide, sulfur and carbon, and an electrolyte salt. Details of the positive electrode composition are described previously.

The positive electrode composition 130 may be self-supporting or may be liquid/molten, in some embodiments. In one embodiment, the positive electrode composition 130 is disposed on an electronically conductive support structure. The support structure, itself may not undergo any chemical reaction during the charge/discharge, and may simply support the positive electrode material during the chemical reactions. The support structure may be present in a number of forms, such as a foam, a mesh, a weave, a felt, or a plurality of packed particles, fibers, or whiskers. In one embodiment, a suitable support structure may be formed from carbon or a metal.

With continued reference to FIGS. 1 and 2, in some embodiments, the energy storage device 100 may include a plurality of current collectors, including a negative current collector 126/134 (also referred to as the anode current collector), and a positive electrode current collector 128/136 (also referred to as the cathode current collector). The anode current collector 126/134 is in electrical communication with the anode compartment 120, and the cathode current collector 128/136 is in electrical communication with the contents of the positive electrode compartment 124. In some embodiments, the anode current collector may function as a shim, as well. Suitable materials for the anode current collector include iron, aluminum, tungsten, titanium, nickel, copper, molybdenum, carbon and combinations thereof. The positive electrode current collector may be in various forms, for example, rod, sheet, wire, paddle, or mesh. Suitable materials for the positive electrode current collector include platinum, palladium, gold, nickel, copper, carbon, tungsten, molybdenum and combinations thereof. The current collector may be plated or clad.

As noted above, a separator 116 (FIGS. 1 and 2) is disposed within the volume of the housing 112. In some embodiments, the separator 116 is a solid separator. In some embodiments, the solid separator is an alkali metal ion conductor solid electrolyte capable of transporting alkali metal ions between the first compartment 120 and the second compartment 124. Suitable materials for the solid separator may include an alkali-metal-beta-alumina, alkali-metal-beta″-alumina, alkali-metal-beta′-gallate, or alkali-metal-beta″-gallate. In some embodiments, the solid separator may include a beta-alumina, a beta″-alumina, a gamma alumina, or a micromolecular sieve such as, for example, a tectosilicate, such as a feldspar, or a feldspathoid. Other exemplary separator materials include zeolites, for example a synthetic zeolite such as zeolite 3A, 4A, 13X, ZSM-5; rare-earth silicophosphates; silicon nitride; or a silicophosphate (NASICON: Na₃Zr₂Si₂PO₁₂).

In some embodiments, the separator may be stabilized by the addition of small amounts of a dopant. The dopant may include one or more oxides selected from lithia, magnesia, zinc oxide, and yttria. These stabilizers may be used alone or in combination with themselves, or with other materials.

In particular embodiments, the separator includes a beta alumina. In one embodiment, a portion of the separator is alpha alumina, and another portion of the separator is beta alumina. In some embodiments, the alpha alumina (a non-ionic-conductor) may help with the sealing and/or fabrication of the cell. In a particular embodiment, the separator is formed of a beta alumina separator electrolyte (BASE), and may include one or more dopants.

As described for some embodiments, at least one of the alkali metals in the positive electrode composition may be sodium, and the separator may be beta-alumina. In another embodiment, the alkali metal may be potassium or lithium, with the separator then being selected to be compatible therewith. For example, in embodiments where the ions include potassium, silver, strontium, and barium cations, the separator material may include beta alumina. In certain other embodiments, where lithium cations are used, lithiated borophosphate BPO₄—Li₂O, may be employed as the separator material.

In some embodiments, the separator may be sized and shaped to provide a maximum surface area for the alkali metal ion transport. In one embodiment, the separator may be a tubular container having at least one wall of a selected thickness; and a selected ionic conductivity. In some embodiments, the thickness of the separator wall may be less than about 5 millimeters. A cation facilitator material may be disposed on at least one surface of the separator, in one embodiment. The cation facilitator material may include, for example, selenium, as discussed in published U.S. Patent Application No. 2010/0086834, incorporated herein by reference.

In some embodiments, the tubular separator 116 may have a cross-sectional profile normal to a vertical axis 132 of the housing 112 (FIGS. 1 and 2). Examples of profiles/shapes include a circle, a triangle, a square, a cross, a cloverleaf, or a star. In one embodiment, the separator 116 may have a length (along the vertical axis 132) to width ratio that is greater than about 1:10. In one embodiment, the length to width ratio of the separator is in a range of from about 1:10 to about 1:5, although other relative dimensions are possible, as described in U.S. application Ser. No. 13/034,184.

Alternatively, the cross-sectional profile of the separator may be planar about the vertical axis 132. A planar configuration (or one with a slight dome) may be useful in a prismatic or button-type battery configuration, where the separator is domed or dimpled. Similarly, the separator may be flat or undulated. In one embodiment, the solid separator may include a shape which may be flat, undulated, domed or dimpled, or includes a shape with a cross-sectional profile that may be an ellipse, triangle, cross, star, circle, cloverleaf, rectangular, square, or multi-lobal.

In some embodiments, one or more shim structures may be disposed within the volume of the housing. The shim structures may support the separator within the volume of the housing. The shim structures may protect the separator from vibrations caused by the motion of the cell during use, and thus reduce or eliminate the movement of the separator relative to the housing. In one embodiment, a shim structure may also function as a current collector, as described herein.

In some instances, the operating temperature of the device/cell may be in a range from about 270 degrees Celsius to about 350 degrees Celsius.

The energy storage device/electrochemical cell is usually assembled in the discharged state. Applying a voltage between the anode and the cathode of the cell can charge the cell. In some embodiments, the sodium chloride in the positive electrode composition (or the cathode material) dissolves into the electrolyte to form the sodium ions and the chloride ions. The sodium ions, under the influence of an applied electrical potential, conduct through the separator and combine with the electrons from the external circuit to form the sodium electrode (i.e., the anode), and the chloride ions react with the cathode material to form a metal chloride and donate electrons back to the external circuit. During discharge, the sodium metal that is often present in the molten form in the anode, donates electrons to the load and the sodium ions conduct back through the separator reversing the reaction. The cell reactions are as follows (charging is to the right):

At positive electrode: nNaCl+M←→MClₙ+nNa⁺+ne⁻

At negative electrode: nNa⁺+ne⁻←→nNa

Overall: nNaCl+M←→MClₙ+nNa

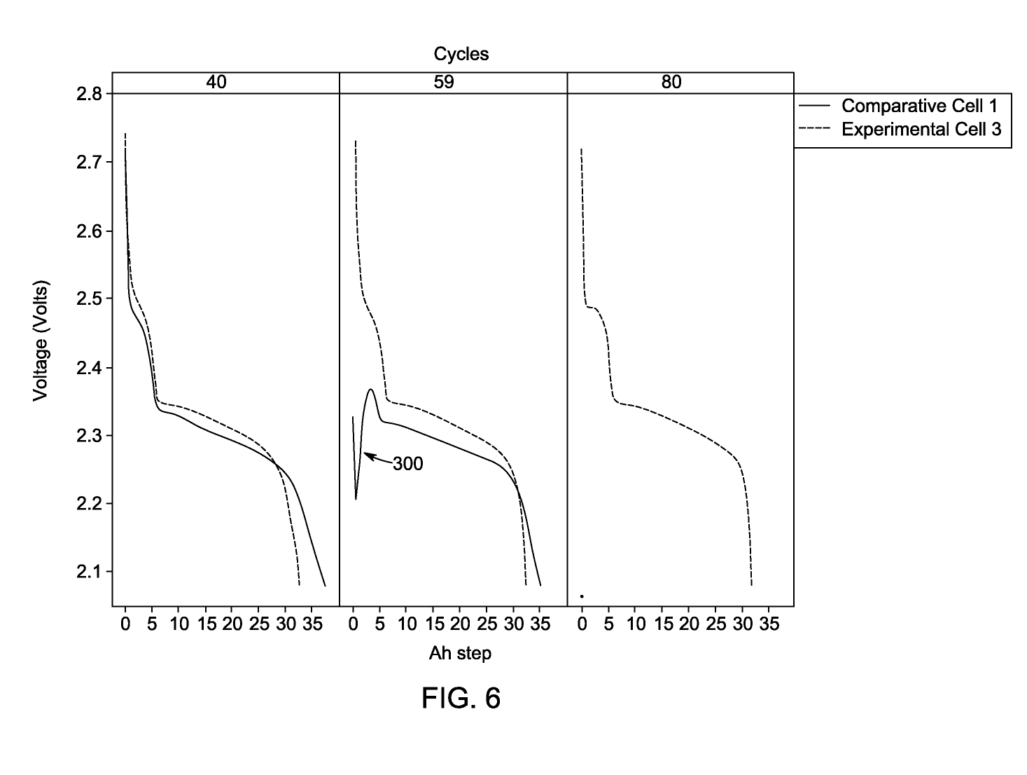

As alluded previously, the high-sulfur containing cells (U.S. Pub. No. 20140178791A1) showed improved charging rate and lower degradation as compared to the low-sulfur containing cells (i.e., the cells built with a low sulfur content in the cathode composition), when operated (including several cycles of charging/discharging) under protocols using less than about 75 percent of a total capacity of a cell. However, when these high-sulfur containing cells are operated over their entire capacity range i.e., discharged to a deep depth of discharge (DOD), these cells show a capacity loss with an accelerated rate as compared to that of the low-sulfur containing cells or the baseline cells (i.e., the cells built with no sulfur content in the cathode composition). Furthermore, the high-sulfur containing cells show a rise in the resistance at the beginning of the discharging steps (typically known as “coup-de-fouet” in the lead-acid Industry). After several cycles, this resistance may rise to a level that prevents the cell from discharging at an intended power (as shown and described with respect to FIG. 6 for a Comparative cell 1).

As used herein, discharging a cell to a full or deep depth of discharge (DOD) means discharging the cell to at least about 90 percent of its entire capacity. In some instance, discharging a cell to a deep DOD may refer to discharging the cell to its entire capacity (˜100 percent). In some instances, discharging a cell to a deep DOD may refer to discharging the cell from about 92 percent to about 98 percent to its entire capacity.

Embodiments of the present invention disclose the positive electrode composition that includes both, sulfur and carbon along with the other constituents of the composition. The inventors of the present invention have observed that by adding an amount of carbon, as disclosed herein, to the high-sulfur containing electrode composition, the cell/device showed a reduced capacity loss (i.e., an improvement in the degradation of the charge acceptance) and a reduced rise in the resistance at the beginning of the discharge steps, when the cell is discharged to the deep depth of discharge (DOD). Some of these results are shown and described in detail below in the Example section. These improvements generally contribute to a fast charging, an improved energy/day, and an improved cycle life of the cell.

In some embodiments, the device is capable of discharging to a deep depth of discharge, when charged to a top of charge (TOC), without a substantial capacity loss. In other words, the cell is capable of retaining its capacity for several cycles, e.g., more than about 100 cycles, and in some embodiments, more than about 200 cycles. As known to those skilled in the art, the term “top of charge” refers to full charge i.e. when a cell is charged to its full capacity in a cycle. A substantial capacity loss, as used herein, means a capacity loss of more than about 15 percent in about 60 cycles. In some embodiments, the substantial capacity loss may be more than about 20 percent in about 60 cycles.

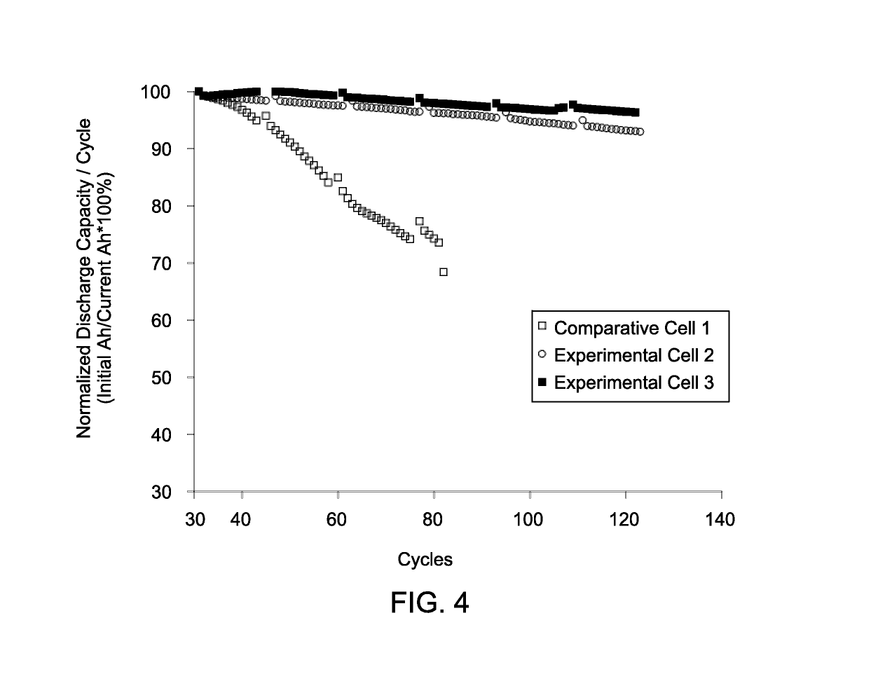

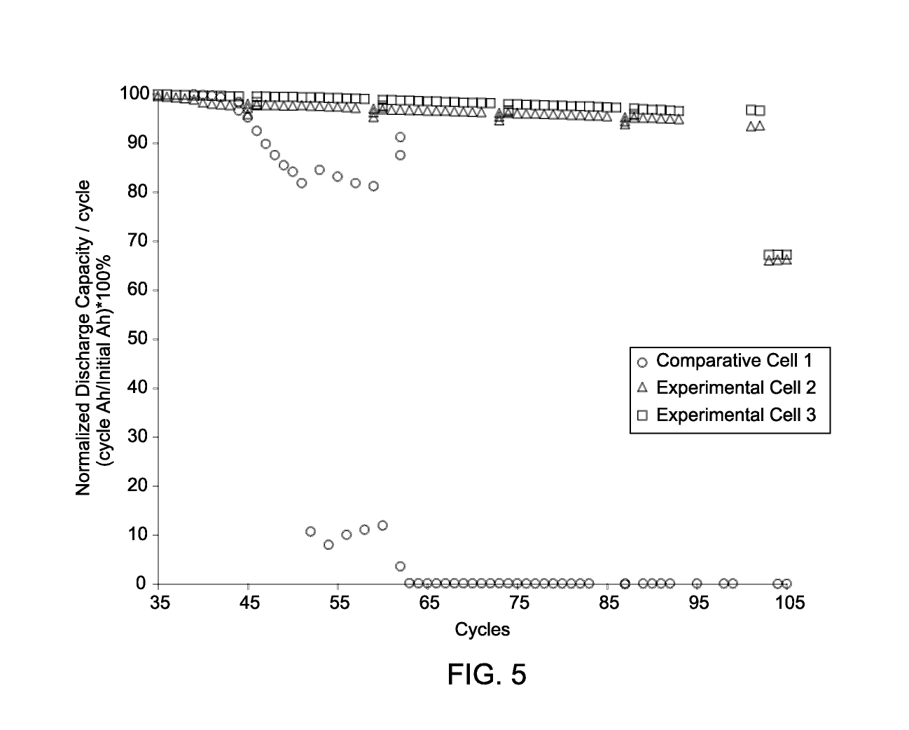

As described below with respect to FIGS. 4 and 5, the experimental cells 2 and 3 constructed according to some embodiments of the invention, showed a capacity loss of up to about 10 percent (even less than about 10 percent) in more than 100 cycles, which is significantly lower than a capacity loss of more than about 20 percent in about 60 cycles for a comparative cell 1 that included a high sulfur content and did not include carbon in the electrode composition. It was further observed that the comparative cell 1 was not able to discharge at all for more than about 80 cycles (FIG. 4). Without being bound by any theory, it is believed that after, e.g., 80 cycles, the resistance at the beginning of the discharging step is so high that the cell cannot perform/operate for more than a few seconds. In contrast, the experimental cells 2 and 3 continued operating for more than about 100 cycles, and in some embodiments, even more than about 200 cycles.

In some embodiments, the device is capable of discharging to a deep depth of discharge, when charged to TOC, without a substantial rise in a resistance at the beginning of a discharge step for more than about 100 cycles. A substantial rise in a resistance, as used herein, refers to a rise in a resistance at the beginning of the discharge steps, such that the cell is not able to perform/operate to provide a desired power. In some embodiments, the cell may undergo microcycling, and thus not be able to perform.

Furthermore, the embodiments described herein allow for operation of a cell that utilizes the cathode more cost-effectively. Typically, the cathode of a conventional cell often contains a considerable amount (e.g., about 140 grams) of nickel. Nickel (II) chloride is not an electronic conductor, so additional nickel is included in the as-built conventional cell to account for the loss of conductivity upon nickel oxidation. In other words, the entire amount of nickel that is typically used (i.e., 140 grams) may not be required for the operation of the cell, but a portion of nickel may be required to maintain a packing density and create a conductive structure. Embodiments of this disclosure, however, contain reduced amounts of nickel, often less than 100 grams, along with an amount of carbon e.g., at least 5 grams of carbon black; and an amount of a sulfur composition e.g., at least 50 grams of troilite (FeS). As known to those skilled in the art, carbon is an electronic conductor. In addition, a significant fraction of nickel, in some embodiments, is oxidized to heazlewoodite (Ni₃S₂) during charging, which is an electronic conductor. Thus, both carbon and sulfur contribute to form or maintain the conductive structure in the electrode.

Another embodiment of the invention is directed to an energy storage system or battery. In some embodiments, a plurality of the energy storage devices or electrochemical cells (each of which may be considered a rechargeable energy storage device), as described herein, may be organized into an energy storage system, for example, a battery. Multiple cells may be connected in series or parallel, or in a combination of series and parallel. For convenience, a group of coupled cells may be referred to as a module or pack. The ratings for the power and energy of the module may depend on such factors as the number of cells, and the connection topology in the module. Other factors may be based on end-use application specific criteria.

In some embodiments, the energy storage devices illustrated herein may be rechargeable over a plurality of charge-discharge cycles. In general, the energy storage device may be employed in a variety of applications; and the plurality of cycles for recharge may be dependent on factors such as charge and discharge currents, a depth of discharge, cell voltage limits, and the like.

In one embodiment, the energy storage system is in the form of an uninterruptable power supply (UPS) device. The primary role of most UPS devices is to provide short-term power (backup power) when the input power source fails. However, most UPS units are also capable in varying degrees of correcting common utility power problems, such as those described in patent application Ser. No. 13/034,184. UPS systems including batteries having electrode compositions as described above may be ideal in those situations where high energy density within the battery is a requirement. In one embodiment, the energy storage system is in the form of a battery backup system for a telecommunication (“telecom”) device, sometimes referred to as a telecommunication battery backup system (TBS).

Other features associated with the energy storage system may constitute embodiments of this disclosure; and some are described in the referenced application Ser. No. 13/034,184. As an example, the system can include a heat management device to maintain the temperature within specified parameters. The heat management device can warm the energy storage system if too cold, and can cool the energy storage system if too hot, to prevent an accelerated cell degradation.

Some other embodiments are directed to an energy management system that includes a second energy storage device that differs from the first energy storage device. This dual energy storage device system can address the ratio of power to energy, in that a first energy storage device can be optimized for efficient energy storage, and the second energy storage device can be optimized for power delivery. The control system can draw from either energy storage device as needed, and charge back either energy storage device that needs such a charge.

Some of the suitable second energy storage devices for the power platform, include a primary battery, a secondary battery, a fuel cell, and/or an ultracapacitor. A suitable secondary battery may be a lithium battery, lithium ion battery, lithium polymer battery, or a nickel metal hydride battery.

### EXAMPLES

The examples presented below are intended to be merely illustrative and should not be construed to be any sort of limitation on the scope of the claimed invention. Unless specified otherwise, all of the components are commercially available from common chemical suppliers.

All nickel/sodium chloride based energy devices/cell were assembled, using the following materials:

TABLE 1

| Material | Source | Properties |
|---|---|---|
| Nickel 255 (metal | Inco Special | 97.9 percent pure, 0.6 square |
| nickel powder, Ni) | products | meters per gram surface area, |
| | | 2.2 to 2.8 micrometers particle |
| | | size) |
| Sodium Chloride | Custom Powders | 99.99 percent pure |
| (NaCl) | Ltd, UK | |
| Sodium Fluoride | Sigma Aldrich | ~99 percent pure |
| (NaF) | | |
| Aluminum powder | Alfa Aesar Item | −100 + 325 mesh particle |
| (Al) | #42919 | size, 99.97 percent pure |
| Iron (metal iron | Alfa Aesar Item | less than 10 micrometers particle |
| powder) (Fe) | #00170, | size, 99.9 percent pure |
| Sodium iodide (NaI) | Sigma Aldrich | ~99 percent pure |
| Iron sulfide (FeS) | Alfa Aesar Item | 99.9 percent pure |
| | #14024 | |
| Carbon | Cabot LITX50 | Ash content <100 ppm |

### Example 1

### Preparation of Devices

Three energy storage devices (i.e. electrochemical cells) were assembled, using the composition provided in Table 2.

Comparative Cell 1: Positive Electrode Composition without Carbon

The sodium chloride (NaCl) had a particle size distribution with 90% by mass less than about 75 micrometers, by sieve analysis. The material was heat treated in an oven at 220° C., before use. Positive electrode materials, including metal nickel powder, sodium chloride, sodium fluoride, sodium iodide, iron, and aluminum powder (as per Table 2), were pressed at ambient room temperature (typically about 18° C.-25° C.), under a linear pressure of about 16-25 kN/cm, using an Alexanderwerk WP50N/75 Roll Compactor/Milling Machine. The resulting agglomerate was ground with a classifier mill into granules; and the fraction containing a particle size of about 0.325 to about 1.5 millimeters was used for the cell assembly.

### Preparation of Electrochemical Cell

The electrochemical cell used commercial hardware (GE Energy Storage Technology ML/3, Revision 2). A closed-end, β″ alumina, separator tube, with a cloverleaf cross-section, separated the inner positive electrode (cathode) compartment from the outer anode compartment. The outer wall of the anode was a carbon steel can, with a square profile. The can size was about 38 mm×38 mm×230 mm. The steel can was the current collector for the anode. A central U-shaped nickel rod was the current collector for the cathode. High temperature, hermetic seals were applied to the open top ends of the cathode and the anode. Details of this construction can be found in J. L. Sudworth, J. Power Sources 100 (2001) 149-163.

The positive electrode granules, prepared using the procedure mentioned above, were placed in the cloverleaf shaped β″-alumina tube through a fill hole at the top of the cell assembly, and the granule bed was densified by mechanical vibration. The cathode was then infiltrated with molten sodium tetrachloroaluminate NaAlCl₄ through the same fill hole at a temperature of about 280° C.; and the fill hole was then closed with a welded cap. Anhydrous, high-purity sodium tetrachloroaluminate was used as received (Aldrich #451584). Nickel tabs were brazed to the fill-hole cap and the steel can for electrification.

Experimental Cells: Positive Electrode Compositions with Carbon

Two electrochemical cells (Experimental Cell 2 and Experimental Cell 3) were constructed using the method described above in Example 1, except using the positive electrode compositions as described in Table 2. The comparative cell 1 was prepared by using the electrode composition that did not include carbon. The positive electrode compositions for Experimental cells 2 and 3 were prepared by adding, respectively, 5.7 grams and 6.7 grams carbon during the premixing, pressing, and grinding steps of the granulation process.

TABLE 2

| | Positive electrode Composition | | | | | | | |
|---|---|---|---|---|---|---|---|---|
| | NaCl | Ni255 | Fe | Al | NaF | NaI | FeS | Carbon |
| | (g) | (g) | (g) | (g) | (g) | (g) | (g) | (g) |
| Comparative | 81.5 | 122.8 | 2.1 | 1.3 | 3.7 | 1.0 | 61.4 | 0.0 |
| Cell 1 | | | | | | | | |
| Experimental | 72.4 | 90.8 | 1.7 | 1.1 | 3.1 | 0.8 | 50.7 | 5.7 |
| Cell 2 | | | | | | | | |
| Experimental | 71.4 | 88.5~ | 1.7 | 1.1 | 3.0 | 0.8 | 50.0 | 6.7 |
| Cell 3 | | | | | | | | |

### Example 2

### Testing of Cells

All cells (Comparative Cell 1, Experimental Cell 2 and Experimental cell 3) were assembled in the discharged state. A standard testing protocol (or cycling protocol) was used.

The protocol was representative of five different duty cycles:
1. Starting at 100 mA and ramping up to 2.75 A over time, charge to 2.67V, then at 2.67V to a current of 500 mA, while at 330° C.
2. Reduce temperature to 300° C. and discharge at −4.5 A to 2.2V.
3. Charge at 10 A to 2.67V, then at 2.67V down to 500 mA.
4. Discharge at −13 W to 2.1V.
5. Charge at 10 A to 2.67V, then at 2.67V down to 500 mA.
6. Discharge at −13 W for 4 hours or to 2.1V.
7. Charge at 20 A to 2.67V, then at 2.67V down to 500 mA.
8. Repeat steps 6 and 7 an additional 9 times.
9. Discharge at −13 W for 6 hours or to 2.1V.
10. Charge at 20 A to 2.67V, then at 2.67V down to 500 mA.
11. Discharge at −14 W to 2.1V.
12. Charge at 10 A to 2.67V, then at 2.67V down to 500 mA.
13. Discharge at −14 W for 28 Ah.
14. Charge at 20 A to 2.67V, then at 2.67V for a total of 13.5 Ah.
15. Discharge at −14 W for 13.5 Ah.
16. Repeat steps 14 and 15 an additional 14 times.
17. Discharge at −14 W for 2 hours or to 2.1V.
18. Charge at 10 A to 2.67V, then at 2.67V down to 500 mA.
19. Discharge at −16.5 W to 2.08V. If Cumulative Ah>425, then go to step 22.
20. Charge at 20 A to 2.67V, then at 2.67V to either current <500 mA or for >4.5 h.
21. Repeat step 19 and 20 until cumulative Ah discharged >425.
22. Charge at 10 A to 2.67V, and then at 2.67V down to 500 mA.
23. Discharge at −4.5 A to voltage <2.2.V, then go to step 18.

Step 1 is the maiden charge, which starts at low current to avoid excessive current densities during the initial production of sodium in the negative electrode. Step 2 is an initial capacity check at 4.5 A. Steps 3 and 4 are a capacity check at 13 W. Steps 6 and 7 are an initial performance measurement on a 13 W, 4 hour TOC (top of charge i.e., full charge) cycle. Step 9 is an extended 13 W discharge to check that the cell can discharge an additional 2 hours after the 4 hour discharge. Step 11 is a capacity check at 14 W. Steps 13 through 15 are an initial performance measurement on a 14 W, PSOC (partial state of discharge) cycle. Step 17 is an extended 14 W discharge to check that the cell can discharge an additional 2 hours after the PSOC discharge. Step 18, is a full charge or top of charge (TOC) before the deep DOD (depth of discharge) cycling. Steps 19 and 20, repetitively exercise the cell over its entire usable SOC (state of charge) range, with steps 22 and 23 providing information about the low power capacity every 425 Ah.

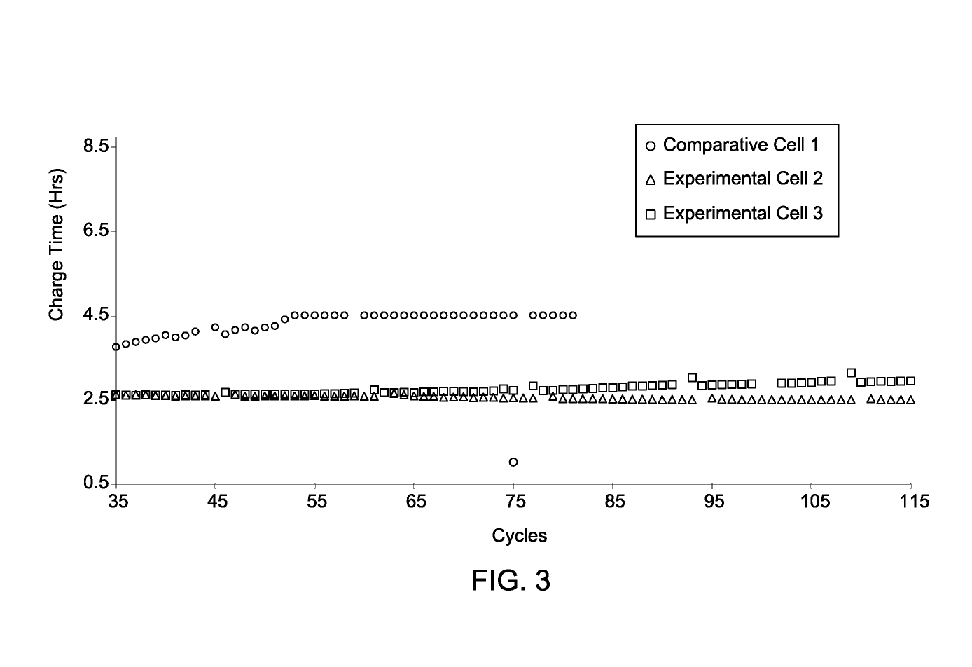

FIG. 3 shows the charge time (i.e., the time taken to charge/recharge a cell after a discharge) for a number of cycles using the cycling protocol provided above. The Experimental Cells 2 and 3 having respectively 2.5 weight percent and 3 weight percent carbon black, charged over their usable capacity faster than the comparative cell 1 (containing high sulfur and no carbon). In addition, the slope of the curve is indicative of an amount of the cell degradation to the charge acceptance, that is, the shallower the slope, the slower the degradation rate of the cell. As shown in FIG. 3, the Experimental Cells 2 and 3 have a lower slope as compared to that of the Comparative Cell 1, indicating less degradation to the charge acceptance in the Experimental Cells 2 and 3 over a given time period. Thus, fast and stable charging is observed for the Experimental Cells 2 and 3.

FIG. 4 represents the discharge capacity per cycle as a function of number of charge/discharge cycles using the cycling protocol provided above. FIG. 4 clearly shows an improvement in retaining the discharge capacity of the Experimental Cells 2 and 3, as compared to that of the Comparative Cell 1 for several cycles. Although an initial discharge capacity of each of the Experimental Cells 2 and 3 was reduced as compared to that of the Comparative Cell 1, the degradation in the capacity (i.e. the capacity loss) was much lower, particularly, during the extended discharge i.e. the deep depth of discharge (DOD), as compared to Comparative Cell 1. It can be clearly observed from FIG. 4 that the Experimental cells 2 and 3 show a capacity loss of about 10 percent for more than about 120 cycles, which is significantly lower than a capacity loss of more than about 30 percent over 80 cycles for the Comparative cell 1.

FIG. 5 represents the discharge capacity per cycle as a function of the number of charge/discharge cycles using the cycling protocol provided above, except that the cell temperature was increased to 320 degrees Celsius, and the charging voltage was increased to 2.77V (with a current cutoff <1.08 A) for steps 19 and 20. Typically, the increased temperature and the charging voltage increase the degradation rate of the capacity loss. As clearly observed from the graph of FIG. 5, the comparative cell 1 showed microcycling behavior at cycle 47, and continuously microcycled after cycle 63. This microcycling may be due to a resistance rise at the beginning of discharge that has progressed to the point at which the cell cannot provide power at 16.5 W for more than a few seconds. Each of the experimental cells 2 and 3 showed a reduced capacity loss (i.e. a reduced degradation to the charge acceptance) under these conditions.

FIG. 6 shows cell-voltage response profiles of the Comparative Cell 1 and the Experimental Cell 3 during the discharge at 40th, 59th, and 80th cycle, detailing the performance degradation of the cells. This data was taken using the cycling protocol provided above except that the temperature of each cell was increased to 320 degrees Celsius, and the charging voltage was increased to 2.77V (with a current cutoff <1.08 A) for steps 19 and 20. A progression in the resistance indicated by an arrow 300 (typically known as “coup-de-fouet” in the lead-acid Industry) for the Comparative Cell 1 can be clearly observed from the resistance profile curve for cycle 59. It was further observed that after cycle 59, the resistance was so high that the Comparative Cell 1 began microcycling and eventually ceased to be able to discharge at all. In contrast, it was observed that the Experimental Cell 3 continued to discharge for more than 80 cycles, and more particularly, even more than 120 cycles. The presence of carbon in the Experimental Cell 3 delayed or prevented the onset of this degradation mode.

Thus, it is clear from the above results that a cell, in accordance with some embodiments of the invention, is capable of discharging to the deep DOD (when charged to the top of charge; TOC) without a substantial capacity loss and without a substantial rise in the resistance (“coup-de-fouet”).

While several aspects of the present disclosure have been described and depicted herein, alternative aspects may be effected by those skilled in the art to accomplish the same objectives. Accordingly, it is intended by the appended claims to cover all such alternative aspects as fall within the true spirit and scope of the disclosure.

What is claimed is:

1. A positive electrode composition comprising granules which themselves comprise:
an electroactive metal,
an alkali metal halide,
an amount of sulfur, wherein a molar ratio of the electroactive metal to the amount of sulfur is between about 1.5:1 and about 10:1; and
an amount of carbon greater than about 0.1 weight percent and less than about 5 weight percent, based on a total weight of the granules.

2. The positive electrode composition of claim 1, wherein sulfur is present in the form of a sulfide composition of formula MₓS_{y}, where M is selected from iron or cobalt, and a ratio of x to y is between about 0.5:1 and 1.5:1.

3. The positive electrode composition of claim 1, wherein the electroactive metal comprises nickel, cobalt, iron or a combination thereof.

4. The positive electrode composition of claim 1, wherein the electroactive metal comprises nickel.

5. The positive electrode composition of claim 2, wherein if M is cobalt, the electroactive metal does not include cobalt.

6. The positive electrode composition of claim 2, wherein the metal sulfide composition of formula MₓS_{y} is selected from FeS, FeS₂, CoS₂ and Co₃S₄.

7. The positive electrode composition of claim 1, wherein the molar ratio of the electroactive element to sulfur in the composition is in a range from about 2:1 to about 5:1.

8. The positive electrode composition of claim 1, wherein the alkali metal halide comprises at least one halide of sodium, potassium, or lithium.

9. The positive electrode composition of claim 1, wherein carbon is present in the form of carbon black or graphite.

10. The positive electrode composition of claim 9, wherein the carbon black has a surface area between about 50 m²/gram and about 1000 m²/gram.

11. The positive electrode composition of claim 1, wherein a molar ratio of the carbon to the electroactive metal is between about 5:95 and 25:75.

12. The positive electrode composition of claim 11, wherein the molar ratio of the carbon to the electroactive metal is between about 10:90 and about 50:50.

13. The positive electrode composition of claim 1, further comprising an electrolyte salt that comprises a complex metal halide, wherein the electrolyte salt has a melting temperature in a range from about 150 degrees Celsius to about 300 degrees Celsius.

14. The positive electrode composition of claim 13, wherein the electrolyte salt is sodium tetrachloroaluminate (NaAlCl₄).

15. The positive electrode composition of claim 1, wherein
the electroactive metal comprises nickel;
the alkali metal halide comprises one or more of sodium chloride, sodium fluoride, sodium iodide; and
sulfur is present in the form of iron sulfide.

16. An energy storage device comprising a first compartment comprising an alkali metal, a second compartment comprising a positive electrode composition, and a solid separator capable of transporting alkali metal ions between the first compartment and the second compartment, wherein the positive electrode composition comprises:
(a) an electrolyte salt comprising a complex metal halide; and
(b) granules that themselves comprise:
(v) an electroactive metal,
(vi) an alkali metal halide,
(vii) an amount of sulfur, wherein a molar ratio of the electroactive element to the amount of sulfur in the granules is between about 1.5:1 and about 10:1; and
(viii) an amount of carbon greater than about 0.1 weight percent and less than about 5 weight percent, based on the total weight of the granules.

17. The energy storage device of claim 16, wherein the alkali metal comprises at least one of sodium, lithium or potassium.

18. The energy storage device of claim 16, wherein the device is capable of discharging to a deep depth of discharge (DOD) when charged to a top of charge (TOC) without a substantial capacity loss for more than about 100 cycles.

19. The energy storage device of claim 16, wherein the device is capable of discharging to a deep depth of discharge (DOD) when the device is changed to a top of charge (TOC) without a substantial rise in a resistance at the beginning of a discharge step for more than about 100 cycles.

20. An energy storage system comprising a plurality of the energy storage devices in accordance with claim 16.
